(19) United States
(12) Patent Application Publication
(10) Pub. No.: US 2013/0307240 A1
(43) Pub. Date: Nov. 21, 2013

(54) SCOOTER

(71) Applicant: Hubert Petutschnig, Brunn am Gebirge (AT)

(72) Inventor: Hubert Petutschnig, Brunn am Gebirge (AT)

(21) Appl. No.: 13/393,387

(22) PCT Filed: Nov. 25, 2011
(86) PCT No.: PCT/AT11/00478

§ 371 Date: Aug. 6, 2013

(30) Foreign Application Priority Data
Nov. 29, 2010 (AT) A 1987/2010
Dec. 3, 2010 (AT) A 2016/2010
Dec. 15, 2010 (AT) A 2078/2010
Jan. 17, 2011 (AT) A 64/2011
Apr. 1, 2011 (AT) PCT/AT2011/000160
Apr. 8, 2011 (AT) PCT/AT2011/000169
Apr. 22, 2011 (AT) A 575/2011
Sep. 6, 2011 (AT) A 1271/2011
Sep. 15, 2011 (AT) A 1334/2011
Sep. 19, 2011 (AT) PCT/AT2011/000381

(51) Int. Cl. B62K 3/00

(52) U.S. Cl. CPC B62K 3/002
USPC 280/87.042

(57) ABSTRACT

The invention relates to a scooter with a frame including a footboard and with two wheel units which lie at a distance from each other in the longitudinal direction of the scooter and support the frame via wheel axles. The frame has a frame part which branches off forwards and/or rearwards with respect to the footboard, preferably lies in the vertical longitudinal centre plane of the scooter and supports at least one pivot shaft which lies in the longitudinal centre plane of the scooter, branches off from the frame part at a predetermined angle with respect to the standing plane of the scooter and defines a pivot axis for the particular wheel unit, and the particular wheel unit is arranged rotatably about the pivot axis such that, when the steering column and/or the footboard is tilted laterally, the wheel unit is pivoted with respect to the longitudinal centre plane.

The invention relates to a scooter according to the preamble of patent claim 1.

The goal of the invention is to provide a structurally simple scooter which can be stably steered in curves and offers great driving enjoyment. Scooters are well known and are used by adults as wells as by children for leisure and sport. Such scooters have a frame part, on which a foot board is fastened or formed. The foot board and/or the frame parts carry a front and a rear wheel unit. On the frame and/or on the foot board, a steering column is fastened which is fastened on the frame part and/or the foot board and which can be pivotally supported, so that the roller can be folded. The steering column can be provided with a handle or a handle bar in the upper steering region. On the frame or on the foot board, in particular below the steering column, a front wheel unit is arranged, and with the steering column or respectively, the handle mounted thereto or respectively, the handle bar, a change in driving direction can be caused by rotating the steering column about its axis by rotating the wheels.

The goal of the invention is to create a scooter with a steering technique that enables a sporty driving, wherein however, it is also possible to steer the scooter with one hand, so that its handling is improved. The scooter according to the invention is in particular intended to also solve the object to provide a sports equipment or transportation means which challenges the sporty character of the user because a certain dexterity, in particular a higher sense of balance, is required than in a conventional scooter. Further, the handling or respectively, the operation is intended to be facilitated by a simple one-handed steering with a preferably vertical steering column. Further, the special configuration of the bearing and suspension of the wheel units are intended to allow a better directional stability and an improved driving behavior than it is possible in conventional scooters.

The invention solves this object with the features set forth in claim 1. In the scooter according to the invention, which includes a frame and a foot board which is connected to the frame or formed from the frame, wherein at least one wheel unit which is required for the directional steering is arranged on the frame and/or the foot board, it is provided that a defined extension of the wheel unit to the left or to the right can occur solely by tilting the piece of sports equipment, which means the foot board and/or a provided steering column to the left or to the right. The wheel unit or respectively, the carrier of the wheel unit is pivoted about the pivot axis when tilting the frame as a result of a foot motion or by moving the steering column by the exerted pressure, so that the wheel unit is extended from its straight ahead position into a direction which is opposite to the direction of the applied pressure or respectively, of the tilting motion. When tilting the frame, the pivot shaft which is tiltably connected to the frame, is tilted along and remains in the longitudinal center plane of the scooter. The wheel axle can thereby be rotated about the pivot axis.

It is noted here that the presence or respectively, the mounting of a steering column or respectively, a handle bar is not absolutely necessary. In principle, the scooter can be used as a piece of sports equipment also without steering column and be steered solely by applying a corresponding foot pressure. However, this places higher demands on the dexterity of the driver.

At least one wheel unit is provided which supported on a carrier which is pivotal about the defined pivot axis. Advantageously, this is the front wheel unit. However, it is also possible to support only the rear wheel unit or the front and the rear wheel unit extendable or respectively, pivotal on supports. It is provided that the respective wheel axle is arranged at a predetermined distance to the pivot axis and/or that a carrier is supported or disposed on the pivot shaft, which carrier is pivotal in the vertically extending plane about the pivot axis and carries the wheel axle, or that the respective wheel axle is supported on the pivot shaft for rotation in the vertically extending plane about the pivot axis which and/or that when the scooter is oriented for straight ahead driving, the wheel axles are perpendicular to the center plane of the scooter. This achieves an easy and sensitively and accurately responding steering of the scooter.

According to the invention, the rear wheel unit can be oriented like the front wheel unit or be constructed conventionally, comparable to a rear wheel of a conventional scooter construction which rear wheel is supported on a rigid axle.

The tilting of the foot board or respectively, the frame about the longitudinal axis of the scooter or respectively, the foot board occurs such that a lateral extension of the steering rod or corresponding exertion of pressure on the foot board and tilting of the foot board causes a tilting of the frame and the foot board about the longitudinal axis of the scooter, thereby achieving a motion of the wheel axle and with this the wheel unit in the form of a pivoting to the right or to the left via the pivot shaft. A tilting to the right initiates a right curve and vise versa.

It is particularly advantageous when the front frame part extends inclined downward away from the foot board and the pivot shaft which defines the pivot axis extends downward from the frame part in the direction of the foot board. With this construction, a very sensitive response of the wheel unit when pivoting the frame part or, respectively the standing surface by foot pressure and/or laterally pivoting the steering column is achieved. A structurally simple construction results, when the pivot axis and the frame part enclose an angle of 90°. The provided wheel units can be characterized in a simple constructive manner in that the wheel unit preferably has a wheel axle which carries two wheels or a roll and which is carried by the carrier. However, it is also possible that at least one wheel unit includes two wheels which are disposed spaced apart on the wheel axle and the wheel axle is supported between the wheels on the carrier or that the carrier is configured as a fork which carries the wheel axle, wherein at least one wheel or a roll lies between the fork ends. Driving technically it can be advantageous when the wheel axle is fastened with its center region on the carrier or is pivotal about the carrier with this region.

According to the invention, a steering column which extends upwards relative to the foot board can be fastened pivotal or optionally, lockable to the frame and/or the foot board. The scooter can thus be steered by foot pressure and/or with the steering column. An embodiment of the scooter with a steering column is advantageous for less sporty or respectively, less practiced drivers.

For driving safety and the operability it is advantageous when the handle which is provided at the end of the steering rod is inclined forward in driving direction and/or that an actuation device for a hand brake device is provided from the steering column or a handle bar or handle rod.

A simple construction of a bearing for the pivot shaft results when the carrier has an end part which is configured shaped tube or forms a support sleeve or respectively, support recess and is supported with the latter on the pivot shaft and/or is pushed with the latter onto the pivot shaft. The pivot shaft can also be configured rod shaped or can include a rod shaped end region and can be received in the frame part by a pivot bearing or a rotating sleeve.

The driving characteristics of the scooter can be influenced in that the wheel axle is located at a distance to the pivot shaft and/or that the wheel axle is located at the height of the foot board and/or that the wheel axles of wheel units which are located in front and behind the foot board are located at the same level as and/or above the level of the foot board and/or in that, when the roller drives straight ahead, the wheel axles are located in the height region between the support of the pivot shaft on the frame part and the foot board. These options result in easy controllable conditions for the person driving the scooter.

A particularly stable drive results when, in an orientation of the scooter for straight ahead driving of the scooter, the respective wheel axle is located at a higher level than the intersecting of the pivot axis with the plane which extends perpendicular to the pivot axis and receives the wheel axle.

For improving the driving properties and increasing the driving safety, a spring unit can be provided which is fastened with one of its ends to the carrier or to the pivot shaft, and with its other end to the frame and directs or respectively, pushes the wheel axle or the wheel unit in driving direction.

It has proven useful when the pivot shaft extends backwards from the frame part in the direction of the foot board and encloses an angle with the support plane whose vertex points in the direction of the foot board and/or when the overall system angle (=individual angle in the case of only one steerable wheel unit or respectively, the angular sum in the case of two steerable wheel units) of the pivot axis or pivot axes and/or the respective pivot shaft(s) relative to the support plane lies between 10° and 90°, preferably between 25 and 85°, particularly between 40 and 80°. This angular range results in a good operability and handling of the scooter in particular when negotiating curves.

An advantageous constructive embodiment of the scooter results when the frame includes frame parts which extend forward from the foot board and extend at an angle to one another, wherein the frame part which is located further away from the foot board carries the pivot shaft and/or that the steering column is carried by at least one of these frame parts.

In an advantageous embodiment of the scooter, the pivot shaft and the carrier can also be built as one piece and the pivot shaft can have the shape of a fork carrier which is supported on the frame part and is rotatable about the pivot axis, wherein the fork region of the fork carrier extends bent in the direction towards the foot board or respectively, has ends which are bent towards the foot board when the scooter is in operating position and is driving straight ahead or respectively, when the fork carrier is oriented in the longitudinal center plane or is horizontal, and the wheel axle lies in the bent end region which serves as carrier, and wherein the wheel axle lies as the case may be on the level of the foot board.

It is advantageous when, in an arrangement in which one wheel unit is arranged in front of the foot board and one behind the foot board which wheel units are each carried by a carrier which is carried by a pivot shaft, the inclination angle of the pivot axis of the front wheel unit is greater than the inclination angle of the pivot axis of the rear wheel unit. If the angle of the front pivot axis is greater than the angle of the rear pivot axis the driving stability and the easygoingness of the steering in curves is increased.

A simple construction results when the frame part extends inclined at an angle to the support surface and in its end region carries the pivot shaft and the carrier which is located on the pivot shaft.

In a further embodiment of a scooter, in particular a scooter in which the front wheel unit as well as the rear wheel unit is carried by a carrier which is supported for pivoting about a pivot shaft, it is advantageous when the foot board is located at a level below a connection line between the wheel axle of the front wheel unit and the wheel axle of the rear wheel unit.

In order to avoid an over-steering or respectively, the driving of curves whose radius is too small at excessive lateral pivoting of the steering column or when exerting an excessive tilting pressure on the stepping surface, the pivot angle of the wheel unit and/or the carrier about the respective pivot axis and/or relative to a vertical axis or the axis of the steering column is limited by a limitation unit, for example a stop.

A simple operation of the scooter results when the steering rod on its upper end which is distal from the foot board, carries a transverse extending handle part as holding part for one-handed operation.

In a particularly advantageous embodiment of a scooter according to the invention, the wheel axles which support the wheel unit each include two wheel axles which extend from a carrier which is pivotally supported on the pivot shaft and each carries a wheel and/or that, when the scooter drives straight ahead, the wheel axles lie in a vertical plane which is perpendicular to the longitudinal direction of the scooter and the axles enclose an angle with the support plane of 5° to 40°, preferably 10° to 30°, in particular 15° to 25°, and/or that the resting point of the wheels on the resting plane lie in this vertical plane.

The goal in this advantageously constructed scooter is to create a kick scooter or respectively, scooter which is constructed structurally simple and which can be stably steered in curves and offers great driving enjoyment and in which an undesired tilting of the same is also avoided at higher curve speeds.

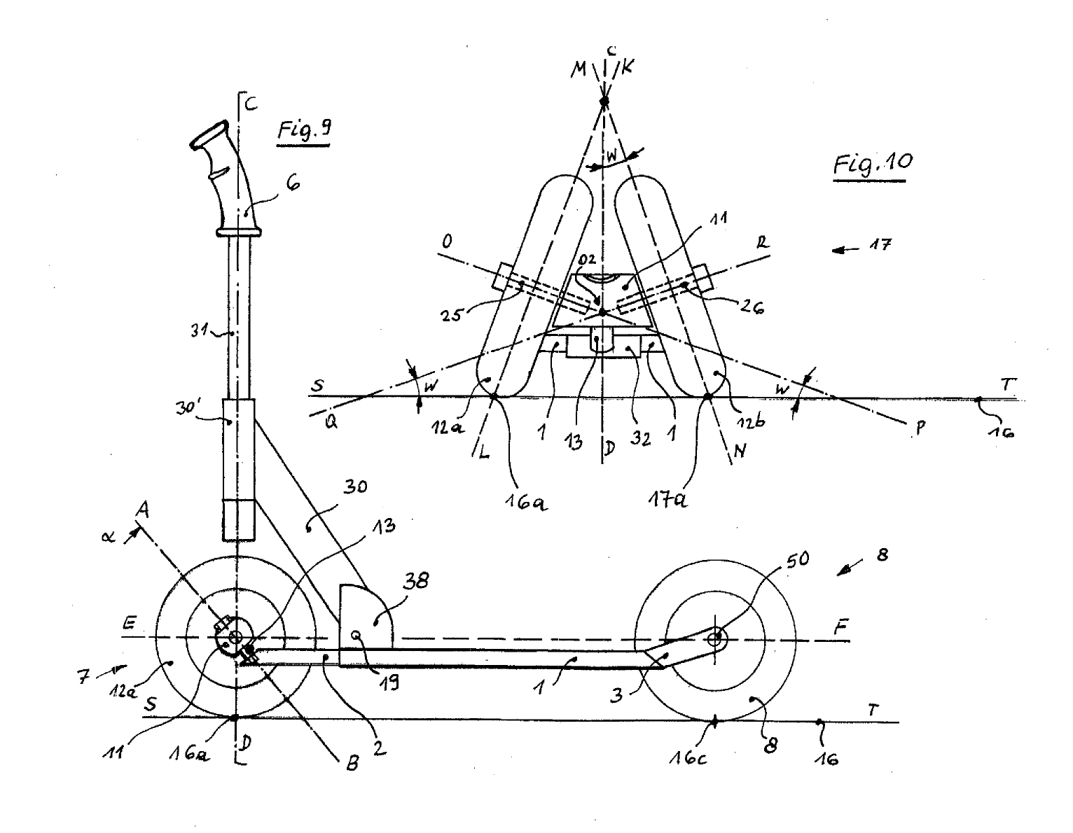

It is provided that a carrier which extends in a vertically extending plane and is pivotal about the pivot axis, is supported or located on the pivot shaft and carries the two laterally extending wheel axles. When the scooter is oriented for straight ahead driving the wheel axles preferably do not project perpendicular to the center plane of the scooter but point upwards at an angle in the vertical plane, so that as a result the two wheels of the steerable wheel unit are no longer arranged parallel to one another, but when viewed from the front are, comparable to the capital letter A, in close proximity to one another in the upper region, and further apart from one another in the lower region. On one hand, this achieves an easy and sensitively and accurately responding steering of the scooter or respectively, on the other hand the tilting of the wheel unit at greater curve forces is avoided, because forces which act on the outer wheel when negotiating a curve, act at an angle against the driven on surface, wherein a wheel suspension/wheel axle is located closer to the scooter frame than to the support point of a wheel which support points toward the ground (FIG. 10/FIG. 12).

The rear wheel unit in such a scooter can be configured in the same manner as the front wheel unit or constructed in a manner as previously described for the other embodiments, or configured comparable to a rear wheel of a conventional scooter construction, which is supported on a rigid axle.

For the driving safety and the operability it is advantageous when the steering column has a handle part which is fastened to the upper end of the steering column and which when viewed in driving direction is inclined forward which accommodates the natural position of the hand which is angled when holding the steering rod.

The driving properties of the scooter can be influenced constructively, in that the wheel axles of wheel units which in driving direction lie in front and behind the foot board are arranged on the same level and/or above the level of the foot board.

Particularly stable driving results when in an orientation of the scooter for straight ahead driving of the scooter, the wheel axles lie on a higher level than the intersection of the pivot axis with the plane which receives the wheel axle and extends perpendicular to the pivot axis.

For increasing the driving safety when negotiating curves whose radius is too small at excessive lateral pivoting of the steering column or when exerting an excessive tilting pressure on the stepping surface, it can be provided that the rotational movement of the wheel carrier is provided with a stop on both outer sides of the wheel carrier in the region of the maximally permitted extension, so that the maximal pivoting of the wheel carrier for driving in curves is limited toward both sides and an over-steering is avoided.

In the following, the invention is explained in more detail by way of examples with reference to the drawings.

FIG. 1 shows a schematic side view of a first embodiment of a scooter according to the invention.

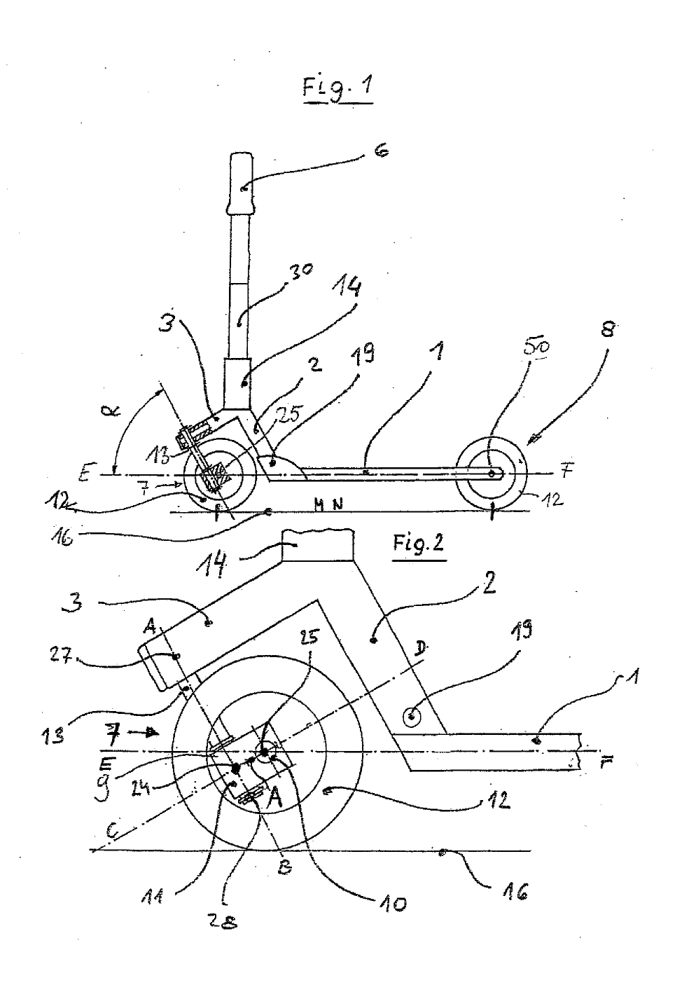

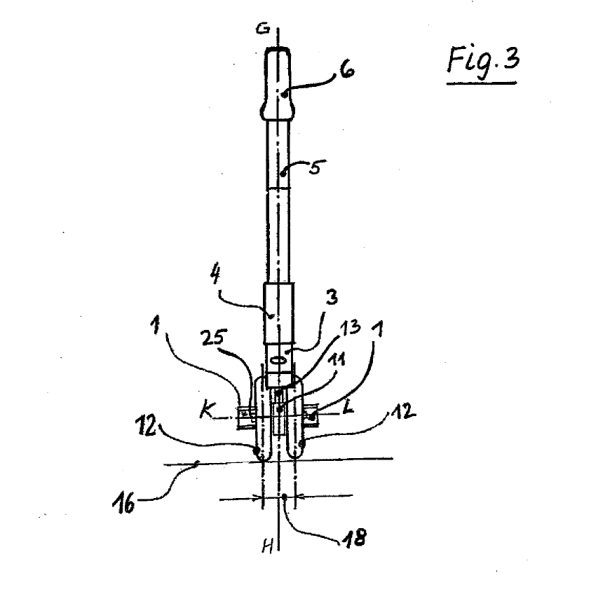

FIG. 2 shows a detail view of the front wheel unit,

FIG. 3 shows a front view.

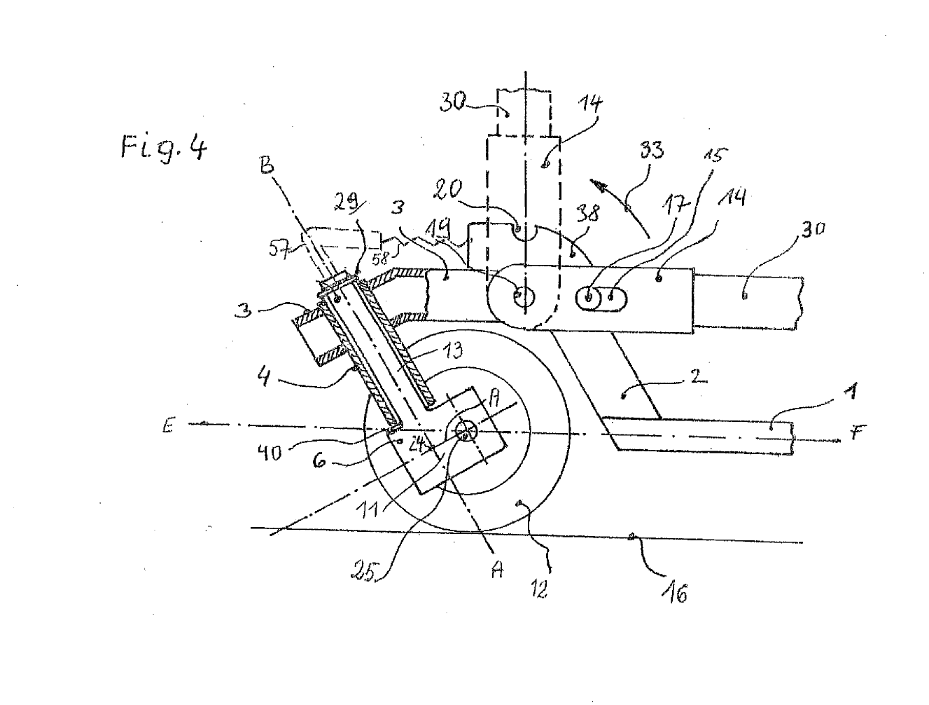

FIG. 4 shows in detail an embodiment of a scooter with a wheel carrier which is fastened on a movable pivot shaft.

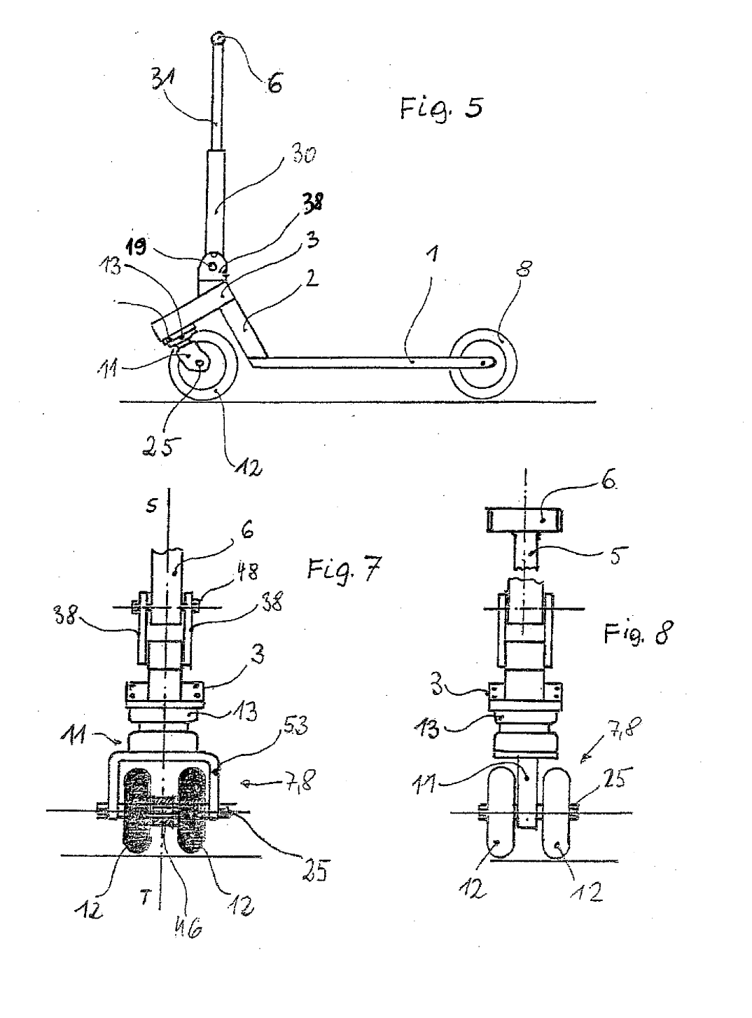

FIG. 8 shows a front view of scooters according to FIGS. 5 to 7.

FIGS. 5 and 6 show an embodiment of a scooter or respectively, the bearing of the pivot axis of a front wheel unit in a side view.

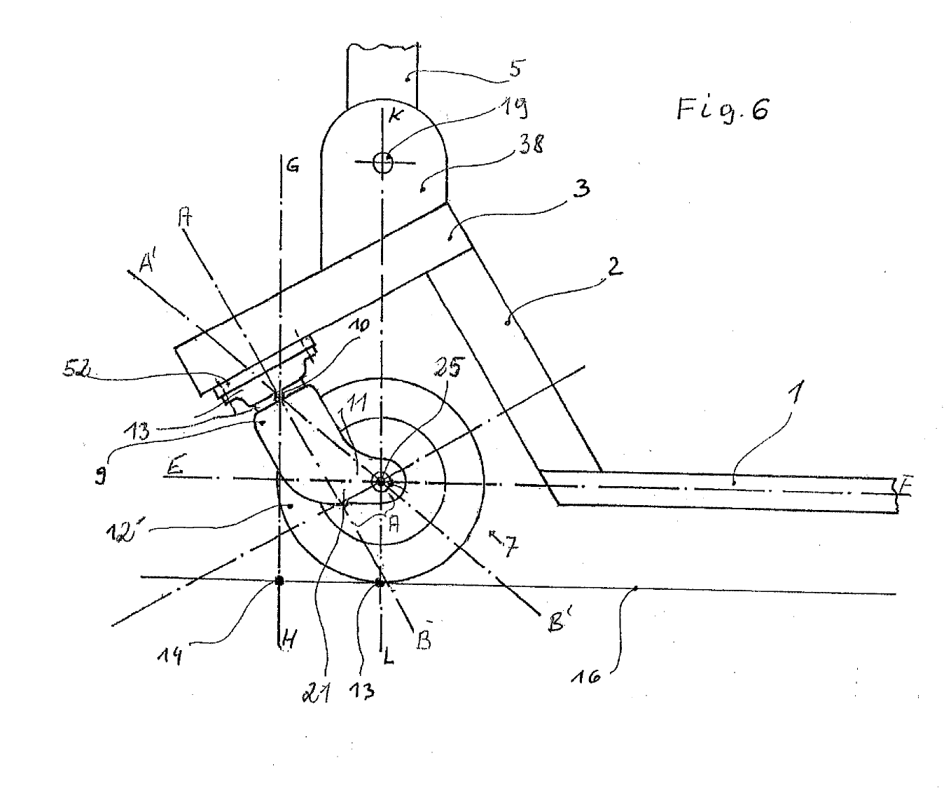

FIGS. 7 and 8 show front views of the scooter according to FIG. 5 and FIG. 6.

FIGS. 9 and 10 show a further advantageous embodiment of a scooter.

In FIGS. 10 and 12 the inclined front wheels in the region of the run surface cross section are shown round and not elliptical for reasons of simplicity.

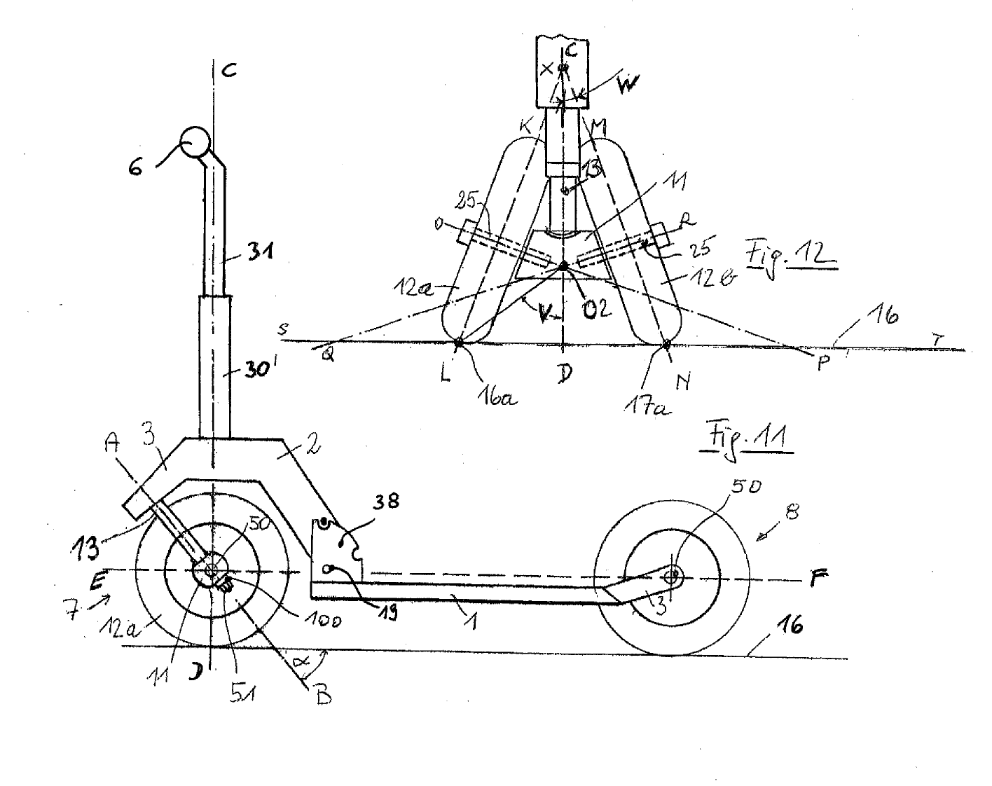

FIGS. 11 and 12 show two particularly preferred embodiments of a scooter.

In the drawings, the scooter is shown oriented for straight ahead driving, which means the wheel axles extend in a plane perpendicular to the longitudinal center plane of the scooter and the carrier also lies in this plane. The scooter is constructed symmetrical with regard to its longitudinal center plane.

FIG. 1 shows a scooter with a foot board 1, which is supported by a frame or respectively, is fixedly connected to the frame, or respectively, is a part of the frame. This frame includes at least two frame parts 2, 3 which are connected to the foot board 1. In principle, the foot board 1 could also be supported on the frame part 2 or constructed integral with the latter or itself be a part of the frame. The part of the frame which is subjected to load by the person during driving represents the foot board. The manner in which the foot board is configured is not important.

In the rear end region of the frame or respectively, the foot board 1 a conventional wheel 12 is supported with a rigidly supported wheel axle 50. This rear wheel unit 8 is supported on the foot board 1 or on the frame part 2 with the wheel axle 50, which frame part 2 optionally extends extended by the foot board.

It is possible, to pivotally connect frame parts, preferably the foot board 1 and the frame part 2, with a pivot bearing 19 or respectively, via a pivot bolt in order to be able to—as known per se—fold the scooter.

In this embodiment, the frame part 2 extends from the foot board 1 inclined upwards in driving direction. A front frame part 3 adjoins the frame part 2 and is connected to the frame part 2 for example by welding. The frame part 3 is inclined forward in driving direction or respectively, inclined forward and downward. A connection part 14 can be pivotally supported by the frame parts 2 and 3 and is optionally formed by a tube part and is connected to the steering column 30 which carries a handle bar 6 in its upper region.

Advantageously, a pivot shaft 13 is either rigidly or rotatably supported or fastened in the front region of the front frame part 3, which pivot shaft 13 defines a pivot axis A, B as shown in FIG. 2. A carrier 11 which supports the wheel axle 25 of the front wheel unit 7 is supported on this pivot shaft 13 for rotation about the pivot axis A, B which is defined by the pivot shaft 13. In case of a rotatably supported pivot shaft 13, the carrier 11 can be securely fastened to the pivot shaft 13.

The angle/the angular sum of the angle α between the support surface 16 and the pivot axis A, B or respectively the pivot shaft 13 is 10° to 90°, preferably 25 to 85°, in particular 40 to 80°.

For driving, it is advantageous when the front wheel unit 7 is formed by two wheels 12 which are arranged at a defined distance 18 adjacent one another, wherein the common wheel axle 25 of these wheels 12 is supported by the carrier 11 as shown in FIG. 3.

When viewed in driving direction, the wheel axle 25 lies thus behind the pivot axis A, B which is defined by the pivot shaft 13, which extends from the frame part 3 downward and rearward in the direction of the foot board 1. In principal, the wheel axle 25 can also lie in front of the pivot axis A, B, however, this position leads to a more instable steering behavior of the scooter with a significant tendency to over-steering.

The wheel axle 25 of the wheel unit 7 lies at a distance A to the pivot axis A, B, namely at a distance A to the pivot axis A, B on a straight line C, D which is perpendicular to the pivot axis A, B. This distance A is given by the center of the wheel axle 25 and the point 24 in which the straight line intersects the pivot axis A, B. The straight line C, D on which the distance A lies, extends perpendicular to the pivot axis A, B through the point 24 and through the wheel axle 25. The wheel axle 25 thus lies in a plane which extends perpendicular to the pivot axis A, B in the point 24 and contains the straight line C, D and is rotatable about the pivot axis A, B. The distance A between the point 24 and the wheel axle 25 is provided and selectable in order to adjust the wheel unit 7 in case of a tilting. This allows to also adjusting the wheel unit 7 to a towed state whereby the stability of the wheel unit 7 for straight ahead driving is assured. In principal, the wheel unit 7 could also be guided to lead.

The wheel distance MN shown in FIG. 1 of the wheels 12 which stand on the support surface 16 and the inclination of the pivot axis A, B relative to the longitudinal axis E, F of the scooter influence the effects of a lateral tilting of the steering column 30 or respectively, a pressure which laterally tilts the foot board 1 with regard to the extent of the pivoting of the carrier 11 about the pivot shaft 13. When the angle α is selected smaller, the rolling radius increases relative to the degree of tilting about the longitudinal axis E, F and when the angle α increases, the rolling radius decreases relative to a tilting movement about the longitudinal axis E, F. Further, an increase of the distance between the points 24 and the wheel axle 25 on the straight line C, D in the direction D leads to an increase in the directional stability, and a decrease of the distance A leads to a decrease of the directional stability, When the wheel axle 25 extends past the point 24 towards the left in FIG. 2, the driving behavior becomes instable. The driving stability of the scooter also increases when the longitudinal axis E, F, which extends through the foot board 1 is on a level which corresponds to the height of the wheel axle 25 or when the longitudinal axis E, F lies below the level of the wheel axle 25.

The steering of the scooter is essentially based on the fact that the front and rear wheel units 7, 8 are arranged centered and aligned along the longitudinal center plane or respectively, the plane of symmetry of the scooter, and that by laterally tilting the foot board 1 or respectively, the steering column 30 relative to the longitudinal axis E, F the pivot shaft is also tilted out of the center, perpendicular position into a direction which is opposite to the tilting and corresponds to the tilting. For example, when the steering column 30 is tilted towards the right relative to the longitudinal axis E, F, the point 28 on the pivot shaft 13 moves toward the left. Further, because of the lever between the point 24 and the support point of the wheel 12 on the support surface 16, the wheel unit 7 is rotated to the right in the same direction of the tilting motion of the steering column 30 or respectively, the foot board 1. The freely rotatable wheel unit is forced to follow the direction of the extended pivot shaft against the position of the support surface against which the wheel unit with the force of the weight which is exerted on the scooter from above. This rotation of the wheel unit 7 as a result of the tilting of the steering column 30 or the foot board 1 then occurs sufficiently, when as shown in FIG. 3 the distance between the two wheels 12 is so great that the required force for the extension or respectively, rotation of the wheel unit 7 can be built up. This means that when increasing the angle α the steering force increases and as a result the distance 18 between the two wheels 12 is to be selected correspondingly greater.

The required distance of the wheels 18 also depends on the constructively required range of motion of the pressure point or respectively the point at which the tilting force acts on the pivot shaft 13. When this point is adjusted to be outside the respective parallel planes which are defined by the wheels 12 of the wheel unit 7, or respectively when this point assumes a distance to the longitudinal center plane of the scooter which is greater than the distance 18, the steering system tilts. The wheel unit is positioned transversely and a total failure of the steering results.

In an advantageous embodiment, the wheel unit 7 can include a fork carrier which carries the wheel axle 25. The wheels 12 are arranged adjacent one another or equidistantly with regard to the spaced apart wheels be combined to a roll and lie between the forks of the fork carrier. The fork carrier is fastened to the carrier 11 with an extension or respectively, the extension which serves as carrier is optionally supported pivotal on the pivot axis 13 or pushed onto or inserted into the latter.

It is advantageous when the wheel unit 7 is formed by two wheels 12, which are positioned at a distance 18 to one another. In the embodiment according to FIGS. 1 to 4, the rear wheel is supported un-steered or respectively, rigidly on the wheel axle 50, however, in principal it can be also configured as steering wheel unit or as front wheel unit in this and all other embodiments.

In practice it has been shown that in an embodiment of a scooter as the one described in the FIGS. 1 to 3, an angle α of 30 to 40° leads to greater rolling radii and with this to a more stable directional behavior, compared to an angle a of for example 70 to 80, when in both cases the lateral tilting of the steering column 30 or respectively, the foot board 1 is selected to be equal. The smaller the angle α is selected, the greater is the minimal rolling radius at the same steering extension of the steering column.

When driving, the driver of the scooter stands with one leg on the foot board 1 of the scooter and holds the handle part 6 of the steering column 30 with one hand and in the balanced state drives straight ahead. A curve can be initiated by pivoting the steering column 30 toward one side, without necessitating a change of the center of gravity. A curve drive is achieved by a tilting of the foot board 1 or respectively, the frame parts 2, 3 about the longitudinal axis E, F and by the pivoting of the front wheel unit 7 which is forced thereby, and also of a rear wheel unit 8 about the respective pivot axis A, B. Only when the scooter steers into a corresponding rolling radius, the driver assumes a slanted position which corresponds to the angular speed, and is directed towards the center point of the curve.

In the embodiment of a scooter according of the invention shown in FIG. 4, the frame part 2 extends from the foot board 1 and transitions into the frame part 3. The frame part 3 carries a rotating sleeve 4, in which the pivot shaft is rotatably supported. The pivot shaft 13 in this embodiment is configured one-piece with the carrier 11. The pivot shaft 13 defines the pivot axis A, B about which the carrier 11 is pivotal. The carrier 11 carries the wheel axle 25 on which a roll or at least one wheel 12 advantageously two wheels 12 which enclose the carrier between them, are supported.

In the region of transition from the frame part 2 into the frame part 3 a pivot bearing 19 is formed, in which the steering column 30 is hinged. The steering column 30 is received by a connection part 14, which has a recess 15 in which a catch pin 17 is supported adjustable against spring action, which catch pin 17 can be received by a catch recess 20 which is formed in a curve track 38 which is configured arch shaped. When actuating the catch pin correspondingly, the steering column can be adjusted in the direction of the arrow 33 into the dashed position where it can be fixed.

The wheel axle 25 is located at the level of the foot board 1 and lies set off behind the pivot axis A, B opposite the direction of driving. As in all embodiments, the wheel axle 25 can lie higher or lower. The pivot axis A, B is inclined at an angle α relative to the support plane 16.

In this embodiment of a scooter as well, the front wheel unit 7 is not connected to the steering column 30 but is carried by the frame i.e. by the frame part 3. As in all embodiments, it is possible in this embodiment to arrange the rear wheel unit 8 pivotal about a pivot shaft 13, for example also a pivot shaft as it is used for the front wheel unit 7.

The sleeve 4 is fixedly and rigidly supported in the front frame part 3 and extends in at the angle a relative to the resting plane 16.

The positioning of the pivot shaft 13 in the rotating sleeve 4 occurs by a safeguard 29 for example a snap ring, and the support of the carrier 11 occurs for example by an angular ball bearing as support surface 40 in form of on the rotation sleeve 4.

A generally applicable example for a resetting of the wheel unit 7 in straight ahead driving position of the scooter is shown in FIG. 4. 57 designates a bent extension of the pivot shaft 13. The end of this extension 57 is connected to the frame part 3 or the curve track 38 via a tension spring 58. When the pivot shaft 13 is rotated about the pivot axis A, B the extension 57 is pivoted against the action of the spring 58 and retracted by the latter into its starting position in the longitudinal center plane of the scooter.

Generally, and also in this embodiment it is possible, to configure the rear wheel unit 8 in the same manner as the front wheel unit 7. In these cases, the foot board 1 is extended by a frame part which corresponds to the frame part 3, which frame part carries the rear wheel unit 7 with a pivot shaft 13.

It is advantageous when the pivot angle of the pivot shaft 13 and/or the carrier 11 is limited by end stops to a predetermined region relative to a vertical to the resting plane 16, so that the curves which are to be negotiated with the scooter are limited to a defined minimal radius.

In an embodiment of a scooter according to the invention shown in FIGS. 5 and 6, the frame part 3 carries a pivot shaft 13, which is pivotally supported in a bearing 52 which is supported on or in the frame part 3. The pivot shaft 13 is supported for pivoting about the pivot axis A, B. The end region of the pivot shaft 13, which is distal to the frame part 3 is configured bent and forms the carrier 11 for the wheel axle 25. This can be a fork carrier, as the one which is designated 53 in FIG. 7 and embraces the wheels 12 from the side. However, it is also possible to configure the carrier 11 in a manner as it is shown in FIG. 8.

The carrier 11 carries the wheel axle 25 on a level of the foot board 1. In principle, the wheel axle 25 can also lie above this level. Further, when driving straight ahead the wheel axle 25 lies on the carrier 11 at the normal distance A behind and above the pivot axis A, B. Advantageously, in this embodiment, or respectively, also in the previously described embodiments the wheel axle 25 of the front wheel unit 7 can be arranged below the upright steering column 30 or respectively below the fastening point of the steering column 30 on the frame part 3 and/or the frame part 2. In such a position, a fast adjustment of the wheel unit 7 when laterally tilting the steering column 30 or respectively, the foot board 1 is achieved.

Also in the embodiment according to FIG. 6, the bearing region of the pivot shaft 13 lies before the point at which the steering column 30 is hinged on the frame part 3 or respectively, on the frame part 2. Such a support of the pivot shaft 13 on the front frame part 3 can also be provided in the previously described embodiments of scooters according to the invention.

Generally, it is possible to limit the pivot angle of the carrier 11 about the pivot axis A, B or respectively about the pivot shaft 13 by means of stops.

Generally, the ground distance of ht steering handle or respectively the steering rod 6 is about 850 to 1000 mm, wherein the wheel distance MN between the front and the rear wheel unit 7, 8 is about 550 to 750 mm.

Further, the wheel unit 7 is always or respectively, generally formed by two wheels 12.

In the embodiment according to FIG. 6, it is advantageous that the carrier 11 is supported as extension of the pivot axis 13 freely pivotal about the pivot axis A, B. The part which represents the carrier 11 on the pivot shaft 13 is attached to the pivot shaft 13 or respectively, the free end of the pivot shaft 13, where it is fixed for example with a screw.

Also in this embodiment, the wheel units 7 and 8 can preferably include two or multiple wheels or also a roll.

Generally, and also in this case spring units can be provided with which the carrier 11 or respectively, the wheel units 7, 8 are pre-tensioned for a straight ahead drive or respectively, urged into or respectively, adjusted to a neutral position for the straight ahead drive. The angle α in the embodiment according to FIG. 6 is 20 to 60°, preferably 30 to 50°, and is preferably about 45°. The wheel axle 25 lies at straight ahead driving in the region between the pivot axis A, B and the foot board 1.

Generally, and as in the previously discussed embodiments, the steering column 30 in a scooter as shown in FIGS. 9 and 10, can also be configured two-part and the handle bar or respectively the handle 6 can be carried by a steering tube 31, which is insertable into the steering column 30.

FIGS. 7 and 8 show differently constructed wheel units 7, 8 which are usable in all embodiments and which each are provided with two wheels, in which wheel units 7, 8 the carrier 11 is either arranged between two wheels 12 or is configured as fork carrier 53, which embraces the wheels 12 which are held at a distance to one another by a distance part 46, or also embraces a roll.

Generally, the wheels 12 are supported either freely rotatable on the wheel axles 25 or the wheels 12 can be fixedly connected to the wheel axles 25, in which case the wheel axles 25 are rotatably supported in bearings in the respective carrier 11.

In principle, the wheel units 7, 8 or respectively the carrier 11 can be supported for rotation about the pivot axis A, B in an angle of 360°. However, in order to achieve a stabilization of the scooter, this angle is advantageously limited with stops to a predetermined angular range.

Generally, it is noted that the foot board 1 can be formed by a widened frame part 2 and, depending on the respective frame and foot board construction can have different positions, shapes and structures.

It has proven advantageous when the wheel units 7, 8 in particular however, the front wheel unit, are each formed by two spaced apart wheels.

It is possible to combine two of the shown and described different embodiments of pivot shafts 13 with carrier 11 and wheel units 7, 8 on each scooter without loss of stability or driving behavior.

In none of the embodiments of the scooters according to the invention, are the wheel units 7, 8 directly steerable or adjustable with a steering rod or respectively steering column 30. The extension or steering of the wheel units 7, 8 occurs exclusively by lateral tilting of the steering column 30 and/or the foot board 1.

The angle α of the pivot axis A, B relative to the support surface is measured when the respective wheel unit 7, 8 is oriented for straight ahead driving or respectively, the scooter stands upright on the support surface 16. The pivot shaft 13 and the carrier 11 in this position lie in the longitudinal center plane of the scooter, the wheel axles 25 when viewed horizontally, stand perpendicular to the longitudinal center plane.

During operation, the steering column 30 is connected to the frame part 2 and/or frame part 3 and/or the foot board 1 in a tiltingly and pivotally fixed manner. The foot board can extend level or arched.

The pivot shaft 13 and/or the carrier 11 pivot or rotate about the defined pivot axis A, B when the steering column 30 or the foot board 1 is tilted. This applies in particular when the carrier 11 and the pivot shaft 13 are fixedly connected. When the carrier 11 is supported pivotally on the pivot shaft 13 or respectively, for pivoting about the pivot shaft 13, the pivot axis A, B extends through the pivot shaft 13. When the pivot shaft 13 and the carrier 11 are fixedly connected the pivot axis A, B is defined by the axis, about which the carrier 11 rotates or respectively, pivots when rotating the pivot axis 13.

A bent up portion which replaces the frame parts 2, 3 can extend towards the front and/or towards the back.

The wheel axle 25 extends perpendicular to the longitudinal center plane of the scooter. The wheels 12 are positioned at a distance 18 to the longitudinal center plane.

In the end region of the pivot shaft which is proximal to the foot board and/or in the end region of the pivot axis which is distal to the foot board, means for limiting the rotation angle S of the pivot shaft and/or the carrier can be formed.

In principle, a unit for limiting the pivot angle could also have stops which are provided on the foot board, and which are configured in the shape of projections and extend upwards or downwards from the foot board 1, against which projections the side surfaces 65 of the carrier 11 and/or the pivot shaft 13 are abuttable. The stop surfaces can be provided with elastic damping stops.

FIG. 9 shows a scooter in a side elevation and FIG. 10 shows a front view of a wheel unit. FIG. 9 shows a scooter which in principle is constructed similar to the previously described scooters and can also have their features insofar as they are compatible. The scooter includes a foot board 1 which is carried by a frame 2 or respectively, is fixedly connected to the latter or respectively, is a part of the frame. This frame 2 includes the foot board 1 and a frame part 3, and a part 30. In principal, the foot board could also be supported on the frame part 2 or formed integral with the latter. The part of the frame which is subjected to load by the person when driving, also in this case represents the foot board 1. The manner in which the foot board is constructed with regard to shape is not relevant.

In the rear end region of the frame or respectively the foot board 1 a conventional wheel 8 is supported on the frame part 3 with a rigidly supported wheel axle 50. This rear wheel unit 8 is supported with the wheel axle 50 on the foot board 1 or respectively, on the fork shaped rear frame part 3 or on the frame part 2, which optionally extends extended through the foot board.

It is possible to pivotally connect the frame part 30 to the foot board 1 and the frame part 2 with a pivot bearing 38 or respectively, via a pivot bolt 19, to be able to fold the scooter as known per se.

In this embodiment, the frame part 30 extends from the foot board 1 in driving direction inclined upwards. A front frame part 30′ adjoins the frame part 30 and is connected to the frame part 30 for example by welding. The frame part 30′ is extended in the extension of the steering column 31 downwards or respectively, carries the steering column 31, wherein the steering column 31 can be configured as telescopic column with the sections 30′ and 31 and carries a handle piece 6 in its upper region.

On its front side with regard to the driving direction, the foot board 1 has the frame part 2 which in its front region carries the pivot shaft 13 which projects at an angle. On this pivot shaft 13 a carrier 11 is supported pivotal about the pivot axis A, B which is defined by the pivot shaft 13, which carrier 11 carries the wheel axles 25, 26 of the front wheel unit 7. In case of a pivot axle 13 which is rotatably supported in the frame part 2, the carrier 11 can be fixedly connected to the pivot shaft 13.

The angle α between the support surface 16 and the pivot axis A, B or respectively the pivot shaft 13 is 10° to 90°, preferably 25 to 85°, in particular 40 to 75° in case of 1 steerable wheel unit, or respectively as angular sum in case of 2 steerable wheel units.

The wheel axle carrier 11 of the wheel unit 7 according to FIG. 10 has the two wheel axles 25 and 26 which are preferably formed by axle bolts and which extend upwards at an angle, wherein the axle bolt 25 forms an angle with the support surface 16 namely between the support surface 16 or respectively the plane ST on one hand, and the axis or respectively, the straight line OP on the other hand, or respectively, the axle bolt encloses an angle with the plane ST and the straight line QR. The angles are of the same size. A plane which is perpendicular to the axle bolts 25 also has as track the straight line KL, for the axle bolt 26 the straight line MN results as track of such a plane.

FIG. 10 further shows a visible shaft section of the pivot shaft 13, for pivoting about which the wheel carrier 11 is supported. The two axle bolts 25 and 26 which extend upwards at an angle are located exactly on a plane which extends transversely to the driving direction when exactly driving straight ahead, wherein the plane is perpendicular to the longitudinal axis EF and normal to the support surface 16 and contains the vertical axis CD or respectively, represents a parallel plane which when viewed in driving direction can lie for constructive reasons further forward or further backward. When driving straight ahead, the pivot shaft 13 and the pivot axis AB lie in the longitudinal center plane of the scooter, with the straight lines CD and EF also lying in this center plane.

Both wheel planes NM and KL extend parallel to the longitudinal axis EF of the scooter. The intersecting line of the wheel planes extends parallel to the longitudinal axis EF of the scooter. The longitudinal axis EF extends in the vertical longitudinal center plane of the scooter parallel to the support plane or respectively to the ground 16.

Driving technically with regard to curve stability it is particularly advantageous when the front wheel unit 7 is formed by two wheels 12a and 12b which form an angle with one another, wherein the two axle bolts 25 san 26 of these wheels 12a, 12b are carried by the carrier 11 as shown in FIG. 10.

The wheel distance 16a/16c shown in FIG. 9 of the wheels 12 and 8 which stand on the support surface 16 and the inclination of the pivot axis A, B to the longitudinal axis E, F of the roller which longitudinal axis E, F is parallel to the support surface, influence the effect of a lateral titling of the steering column 30/30′ or respectively, of a lateral pressure which tilts the foot board 1 with regard to the extent of the tilting of the carrier 11 about the pivot shaft 13. When the angle α is selected to be smaller, the roll radius increases relative to the degree of tilting about the longitudinal axis E, F and when the angle α increases, the roll radius decreases relative to a tilting movement about the longitudinal axis E, F. The driving stability of the scooter also is improved when the surface or respectively, stepping surface which extends at the foot board 1 is located below the longitudinal axis EF which connects the front and rear wheel axles.

The steering of the scooter is essentially based on the fact that the front and rear wheel units 7, 8 are arranged along the longitudinal center axis or respectively axis of symmetry of the scooter, in particular centered and aligned and/or symmetrical to the latter, and that by laterally tilting the stepping surface 1 or respectively the steering column 30 relative to the longitudinal axis E, F the pivot axis 13 is also pivoted out of the centered perpendicular position into a direction which is correspondingly opposite to the direction of tilting. For example, when the steering column 30 is tilted to the right relative to the longitudinal axis E, F, the point 28 on the pivot shaft 13 moves toward the left. Further, due to the resulting lever between the pressure point which on one hand acts in the system and the support point of the wheel 12 on the support surface 16 the wheel unit 7 is rotated in the same direction of the tilting motion of the steering column 30 or respectively, the foot board 1 toward the right. This rotation analogously occurs the stronger the greater the angle α has been constructively selected. The extension of the wheel unit 7 due to the tilting of the steering column 30 or the foot board 1 occurs then in sufficient form when, as shown in FIG. 10, the distance between the two wheels 12a and 12b is so great that the required force for extending or respectively rotating the wheel unit 7 can be built up.

The two wheels 12a, 12b of the wheel unit 7, 8 when mounted are located closer to each other with their upper rim regions so that the force which is transferred by the wheel axles via the wheels is conducted obliquely outwards against the support plane and/or that the wheel axle bolt of the wheels 12a 12b of the wheel unit 7 when mounted lie closer to the vertical longitudinal center plane of the scooter than the support points 16a, 17a of the wheels 12a 12b on the driven on ground or respectively, on the support surface 16 and/or that the wheel screws which are provided for fastening the wheels of the wheel axles 25, 26 of the wheel unit 7 which are configured as axle bolts do not transfer the support points 16a, 17a of the wheels 12a, 12b even at the smallest constructively drivable curve radius.

When the angle α is increased, the steering force increases as well as the tendency for destabilization of the steering and as a result the distance of the support points 16a, 17a between the two wheels 12a, 12b is to be selected correspondingly greater. The required width of the wheel distance also depends on the constructively provided centrifugal forces for the smallest curve radii to be negotiated at the maximal speeds permitted therefore.

When driving, the driver of the scooter stands with one leg on the stepping surface 1 of the scooter and holds with one hand the handle part 6 of the steering column 30 and in the balanced state drives straight ahead. A curve can be initiated by pivoting steering column 30 to one side without requiring a change of the center of gravity. A curve drive is achieved by tilting the stepping surface 1 or respectively the frame parts 2, 3 about the longitudinal axis E, F and by the forced extension of the front wheel unit 7 and a rear wheel unit 8 about the respective pivot axis A, B which is caused by the tilting. Only when the scooter steers into a corresponding roll radius the driver assumes a slanted position proportional to the angular speed, which position points toward the center of the curve.

It is further provided that the wheel axles 25, 26 which extend from the carrier when the scooter drives straight ahead, lie in a plane which contains the axis CD and is perpendicular to the longitudinal center plane CD-EF, and that the wheel axles 25, 26 and the support points 16a, 17a of the wheels 12a, 12b lie in this transverse plane which is perpendicularly to the longitudinal center plane and extends vertically. Expediently, the wheel axles 25, 26, 50 of the wheel units 7, 8 which lie in front of and/or behind the foot board 1 lie on the same level or preferably above the level of the foot board 1. For limiting the rotational angle the carrier 11 can have a pivot bolt 13 which is fixedly connected to the carrier 11 and/or the carrier 11 can be supported rotatably, preferably for rotation about an angular range which is limited by a stop, on a pivot shaft 13 which extends from the frame part 3 and which is preferably fixedly connected to the frame part 3.

The carrier 11 rotates about the pivot axis AB and/or the pivot shaft 13, depending on how these parts are supported. The two wheel axles 25, 26 and the wheels 12a, 12b which are carried by the wheel axles are also rotatable about the pivot axis AB. A single wheel axle 25 is also pivotal about the pivot axis AB and carries a wheel unit i.e. two wheels or a roll.

FIGS. 11 and 12 show a particularly advantageous embodiment of a scooter according to the invention. On the frame part 3 which is inclined forward and downward, a pivot shaft 13 is fastened in particular welded or bolted. The frame part 3 is connected, in particular pivotal and fixable, to the foot board 1 via a frame part 2 and carries a steering rod 31 with a handle bar 6. The pivot shaft 13 is oriented downward and backward in the direction toward the foot board 1 at the angle α and carries a wheel unit 7. The wheel unit 7 includes two wheels 12a, 12b which are inclined toward one another as shown in FIG. 12. In the end region of the pivot shaft 13 a carrier 11 or rotatably supported on the pivot shaft 13, which carrier 11 carries the two wheel axles 25, which extend outward from the carrier 11.

As can be seen from FIG. 12, the wheel planes whose tracks are designated MN or respectively LK, together enclose an angle of 2 W. It is provided that 10°≦W≦30°, preferably 15°≦W≦25°. In particular, it is advantageous when 17°≦W≦23°. The vertex of the angle W lies in point X.

The angle W is thus formed between a vertical center plane which extends between the longitudinal direction EF of the scooter and the respective wheel plane MN or respectively, KL. The track of the longitudinally extending vertical plane is designated CD.

Further, a point O2 is defined by the wheel axles 25 on the carrier 11, namely at the position where the wheel axle 25 traverses the vertical center plane CD. This point O2 also lies on the axis AB of the pivot shaft 13. The angle V of a straight line through the point O2 and the respective support point of the wheel plane 16a or respectively 17a on the support surface 16 and the vertical center plane is designated V and is 30°≦V≦50°, preferably 35°≦V≦45°. These angles V, W are also advantageous for an embodiment of the scooter as the latter is shown in FIGS. 9 and 10. The angle W and the angle V are respectively measured in the vertical center plane, which contains the support points 16a, 17a, the point O2, the point X and the wheel axle 25. It is advantageous when the carrier 11 is pivotally fixed on the pivot shaft 3 with a nut 51 which is screwed to the end of the pivot shaft which end is provided with a threading. A plastic disc 50 can be inserted between the carrier 11 and the nut 51 and by tightening or loosening of the nut 51 the ease with which the carrier 11 is pivoted on the pivot shaft can be adjusted or respectively changed.

These two angles W and V determine the geometry of the arrangement of the wheels or respectively, predetermine the distance of the two wheels and their inclination angle relative to the vertical plane CD. These angles vary depending on the distance of the wheels, the diameter of the wheels and the inclination of the wheels. It has been shown however, that when observing these optimized angles an optimal driving behavior is also given at a minimal risk of falling.

It is noted that the wheel planes MN, KL extend parallel to the longitudinal axis EF of the scooter and the intersecting line of these two planes which extends though the point X also extends parallel to the longitudinal axis EF, which in turn is oriented parallel to the support surface 16 of the roller. This means that the font most and rear most points of the wheels 12a and 12b with regard to the driving direction have the same distance.

In a further preferred embodiment, a motor-driven scooter is provided according to the invention, wherein accumulators are provided in particular in frame sections 1, 2, 3 which accumulators supply an E-motor, preferably in the form of a wheel hub motor with electrical energy, wherein the power control for the drive is expediently located in the region of the handle part 6.

What is claimed is:

1-40. (canceled)

41. A scooter comprising:
a frame (2, 3) comprising a foot board (1);
two wheel units (7, 8) spaced apart in a longitudinal direction of the scooter, and supporting the frame (2, 3) via wheel axles (25, 26, 50), wherein the frame (2, 3) has a frame part (3, 2) which with regard to the foot board (1) extends forward and/or backward, and which preferably lies in a vertical longitudinal center plane of the scooter;
at least one pivot shaft being positioned in the longitudinal center plane of the scooter and extending from the frame part at a predetermined angle (α) relative to a standing surface (16) of the scooter, said at least one pivot shaft defining a pivot axis, said frame part (3, 2) supporting the at least one pivot shaft (13); and
wherein at least one of the two wheel units (7, 8) is constructed as steerable wheel unit and is arranged pivotal about the pivot axis (A, B) so that when laterally tilting the steering column (30) and/or the foot board (1) a tilting of the wheel unit (7, 8) relative to the longitudinal center plane results, and wherein the wheels which are carried by the wheel axles or planes respectively defined by the wheels extend slanted at an angle to each other of 20°-60°, in particular 34° to 46°, and respective regions of the wheels that are distal to the ground are closer to each other than regions of the wheel that are proximate to the ground.

42. The scooter of claim 41, wherein the respective wheel axle(s) (25, 26) which preferably carry one wheel pair, is (are) arranged at a predefined distance (A) to the pivot axis (A, B) and are preferably pivotal about the pivot shaft (13) in a plane which is defined by the pivot shaft (13) and which extends perpendicular to the pivot axis (A, B) which is defined by the pivot shaft (13).

43. The scooter of claim 41, further comprising a carrier (11) supported or located on the pivot shaft (13), said carrier being pivotal about the pivot axis (A, B) and extending in the vertically extending plane, said carrier (11) carrying the wheel axles (25, 26), or wherein the respective wheel axles (25, 26) are supported on the pivot shaft (13) pivotal about the pivot axis (A, B) in the perpendicularly extending plane.

44. The scooter of claim 41, wherein the frame part (3) extends inclined downward and away from the foot board (1) and that the pivot shaft (13) which defines the pivot axis (A, B) extends downward from the frame part (3) in the direction of the foot board (1), and/or wherein in a further preferred embodiment a pivot shaft projects from the frame part (2) forward and upwards along the pivot axis AB for receiving the carrier (11).

45. The scooter of claim 41, characterized in that the wheel unit (7, 8) has a wheel axis (25, 26) which preferably carries two wheels or a roll, which wheel unit is carried by the carrier (11), and/or in that at least one wheel unit (7, 8) includes two wheels which are positioned at a distance to each other on the wheel axle, and the wheel axle between the wheels is supported on the carrier (11).

46. The scooter of claim 41, wherein on the frame and/or the foot board a steering column (30, 31) is fastened lockable and optionally pivotal, which steering column extends upwards from the frame, and/or in that the steering column (30, 31) in particular its upper end has a handle which is preferably tilted toward the front and/or in that from the steering column or a steering or handle bar, at least one braking device for at least one wheel unit is carried.

47. The scooter of claim 41, wherein the carrier (11) has a rod or tube-shaped end part or forms a bearing sleeve (9) and is supported with the end part or the bearing sleeve on the pivot shaft (13) and/or is attached to the pivot shaft (13) or inserted into the pivot shaft (13) and/or in that the pivot shaft (13) is configured rod shaped or includes a rod shaped end region and is received by a rotational bearing or a rotational sleeve (4) in the frame part (3) and/or that the wheel axis(es) (25, 26) are held by the carrier (11) at a distance to the pivot shaft (13).

48. The scooter of claim 41, wherein the pivot shaft (13) extends backwards from the frame part (3) in the direction toward the foot board (1) and encloses an angle (a) with the standing plane (16), whose vertex points in the direction of the foot board (1).

49. The scooter of claim 41, wherein the pivot angle of the wheel unit (7, 8) and/or of the carrier (11) about the respective pivot axis (A, B) and/or relative to a vertical axis or the axis of the steering column is delimited by a delimitation unit, for example a stop.

50. The scooter of claim 41, wherein the wheel axles which support the wheel unit (17) include two wheel axles (25, 26) which extend from a carrier (11) which is povitally supported on the pivot shaft (13) and each carry a wheel (12a, 12b) and/or that the carrier (11) is pivotally supported on or situated on the pivot shaft (13) about the pivot axis defined by the pivot shaft (13) and carries the wheel axes (25, 26) and/or that the pivot axis (13) extends from the frame (2, 3) upwards and is fastened on or rotatably supported on the frame or frame part (2, 3) and the carrier is supported or formed or fastened in the foot board distal region of the pivot shaft (13) or that the pivot shaft (13) extends downward from the frame (2, 3) and is rotatably supported or fastened on the frame or frame part (3) and the carrier (11) is supported or formed or fastened on the foot board proximate region of the pivot shaft (13).

51. The scooter of claim 41, wherein the wheel axles (25, 26) lie in a vertical plane which is perpendicular to the longitudinal direction (EF) of the scooter and/or that the axes (OP/QR) of the wheel axles (25, 26) enclose an angle with the standing plane (16) of 10° to 35°, preferably 15° to 25°, in particular 17° to 23°, wherein the support points (16a, 17a) of the wheels (12a, 12b) lie in the vertical plane which extends through the axis of the carrier (11) which axis extends transverse to the driving direction and/or through the wheel axes (25, 26) and/or ion that when the scooter drives straight ahead, the wheel axles which extend from the carrier (11) lie in a plane which contains the axis CD and is perpendicular to the longitudinal center plane (CD-EF), wherein the wheel axles (25, 26) and the support points (16a, 17a) of the wheels (12a, 12b) lie in this vertically extending transverse plane which is perpendicular to the longitudinal center plane.

52. The scooter of claim 41, wherein the angle or the angular sum (a) of the respective pivot axis (A, B) and/or the respective pivot shaft (13) to the standing plane (16) is between 10° and 90° preferably between 25° and 85°, in particular between 40° and 80°, or in the case when two steerable wheel units are provided the preferred angular sum represents the two pivot axis angles.

53. The scooter of claim 41, wherein the carrier (11) which carries the two wheel axles (25, 26) has a bore or axle bolt which is tilted at an angle (a) corresponding to the straight line AB, wherein the angle (a) between the longitudinal axis EF and the straight line AB is between 10° and 90°, preferably between 30° and 80°, in particular between 40° and 70°.

54. The scooter of claim 41, wherein the wheel unit (7) has two wheels (12a, 12b) which are inclined in the shape of the capital letter A and which preferably have wheel circumferences which in the upper region are closer to each other, and which are rotatably supported on the wheel axles (25, 26/25, 26) and/or in that the two wheels (12a, 12b) of the wheel unit (7, 8) when mounted lie closer to one another with their upper border regions, so that the forces which are transmitted by the wheel axles via the wheels are conducted obliquely outward against the support plane and/or in that the wheel axle bolts of the wheels (12a, 12b) of the wheel unit (7) when mounted lie closer to the vertical longitudinal center plane of the scooter than the support points (16a, 17a) of the wheels (12a, 12b) to the driven on ground or respectively to the support plane (16).

55. The scooter of claim 41, wherein the vertex X of the sharp angle lies in the intersecting line of the planes which extend parallel to the driving direction or to the longitudinal direction EF of the scooter or parallel to the standing plane (16) and/or in that the geometry of the wheel position is constructively defined by a vector which form example is projected by the straight line (L, O2) (FIG. 12), which starts in a support point (16a/17a) of each of the wheel (12a/12b) and ends in the intersecting point O2 of the two wheel axles (25, 26), and encloses an angle V between the standing points (16a, 17a) with the vertical center plane CD of respectively 30°<50°, preferably 35°<45°.
